(19) United States
(12) Patent Application Publication
(10) Pub. No.: US 2003/0165692 A1
(43) Pub. Date: Sep. 4, 2003

(54) Coagulates containing microcapsules

(76) Inventors: Friedrich Koch, Koln (DE); Ciro Piermatteo, Leverkusen (DE)

Correspondence Address: BAYER CHEMICALS CORPORATION, 100 BAYER ROAD, PITTSBURGH, PA, 15205, US

(21) Appl. No.: 10/348,249

(22) Filed: Jan. 21, 2003

(30) Foreign Application Priority Data
Jan. 24, 2002 (DE) 10202573.8
Mar. 28, 2002 (DE) 10213984.9

(51) Int. Cl. B32B 27/00

(52) U.S. Cl. 428/423.1; 428/500

(57) ABSTRACT

Polymer-coated substrates containing microcapsules in the polymer coat.

The invention relates to coagulates containing microcapsules, to a process for producing them and to their use.

### BACKGROUND ART

Coagulates for the purposes of this invention are substrates on whose surface polymers have been deposited by coagulation.

It is an object of the present invention to durably equip substrates with active components.

It has now been found that this object is achieved by polymer-coated substrates containing microcapsules in the polymer coat.

The invention accordingly provides polymer-coated substrates containing microcapsules in the polymer coat.

The substrates are preferably sheetlike in shape; more particularly, the substrates are flexible as well.

Preferred substrates include leather, textile, web, paper, leatherlike material (ie textile sheet materials produced using plastics) or plastics films or sheets.

Useful polymers include for example polyurethanes, polyurethaneureas, polyacrylonitriles or copolymers of styrene, especially acrylic-butadiene-styrene copolymers.

Preferred polyurethanes or polyureas are polyaddition products of polyisocyanates and compounds having active hydrogen atoms. They are preferably hydrophobic, which is preferably understood to mean that they do not form stable dispersions or solutions with water without further auxiliaries. They can contain certain formative components for example from the group of the silicone resins, the polyethers containing aromatic segments in the molecule, the polyesters containing aromatic segments in the molecule and/or the perfluorocarbon resins.

Preferred starting materials for preparing the polyurethanes or polyurethaneureas are

1. any desired organic polyisocyanates, preferably diisocyanates of the formula Q(NCO)₂, where Q is in particular an aliphatic hydrocarbon radical having 4 to 12 carbon atoms, a cycloaliphatic hydrocarbon radical having 6 to 15 carbon atoms, an aromatic hydrocarbon radical having 6 to 15 carbon atoms or an araliphatic hydrocarbon radical having 7 to 15 carbon atoms. An extensive enumeration of suitable diisocyanates can be taken for example from DE-A 31 34 112, DE-A 28 54 384 and DE-A 29 20 501.

Examples of such preferred diisocyanates are tetramethylene diisocyanate, hexamethylene diisocyanate, 1-methyl-1,5-diisocyanatopentane, 2-methylene-pentane 2,5-diisocyanate, 2-ethylbutane 1,4-diisocyanate, dodecamethylene diisocyanate, 1,3- and 1,4-diisocyanatocyclohexane, 1-methyl-2,4- and -2,6-diisocyanatocyclohexane, 3-isocyanatomethyl-3,5,5-trimethylcyclohexyl isocyanate (isophorone diisocyanate), 4,4′-diisocyanatodicyclohexylmethane, 4,4′-diisocyanato-2,2-dicyclohexylpropane, mono-, bis-, tris-, or tetraalkyl-dicyclohexylmethane 4,4′-diisocyanates, lysine alkyl ester diisocyanates, oligomers or homopolymers of m- or p-isopropenyl α,α-dibenzyldiisocyanates according to EP-A 1 30 313, 1-alkyl-2-isocyanatomethylisocyanatocyclohexanes, 1-alkyl-4-isocyanatomethylisocyanatocyclo-hexanes according to EP-A 1 28 382, 1,4-diisocyanatobenzene, 2,4- or 2,6-diisocyanatotoluene or mixtures of these isomers, 4,4′- and/or 2,4′- and/or 2,2′-diisocyanatodiphenylmethane, 4,4′-diisocyanato-2,2-diphenylpropane, p-xylylene diisocyanate and α,α,α′,α′-tetramethyl-m- or -p-xylylene diisocyanate and also mixtures consisting of these compounds.

Particular preference is given to using the (cyclo)aliphatic diisocyanates mentioned.

It is also possible, of course, to use, exclusively or additionally, the more highly functional polyisocyanates known per se in polyurethane chemistry or else modified polyisocyanates known per se which have for example carbodiimide groups, allophanate groups, isocyanurate groups, urethane groups and/or biuret groups.

2. polyhydroxy compounds of the kind which is known per se in polyurethane chemistry that have molecular weights above 200 g/mol, for example 400 to 10 000 g/mol, preferably 500 to 5 000 g/mol, and melting points below 60° C. and preferably below 45° C. The polyhydroxy compounds used preferably have a water solubility of less than 100 g/l at 20° C. and especially of less than 50 g/l. Preference is given to using the corresponding dihydroxy compounds. The inclusion of small fractions of compounds which are tri- or more highly functional in the sense of the isocyanate polyaddition reaction in order to obtain a certain degree of crosslinking is similarly possible as the aforementioned possible inclusion of tri- or more highly functional polyisocyanates for the same purpose. It is further preferable for the corresponding polyhydroxy compounds to be predominantly polymerized from aliphatic components.

Preferred hydroxy compounds include the hydroxypolyesters, hydroxypolyethers, hydroxypolythioethers, hydroxypolycarbonates and/or hydroxypolyesteramides known per se in polyurethane chemistry. The contemplated hydroxyl-containing polyesters are for example reaction products of polyhydric, preferably dihydric and optionally additionally trihydric, alcohols with polybasic, preferably dibasic, carboxylic acids.

When tri- or more highly hydric alcohols are used for preparing the polyesters, the (additional) use of monobasic carboxylic acids is possible as well. Conversely, when relatively highly basic carboxylic acids are used, then monohydric alcohols can be used (in addition).

Instead of the free polycarboxylic acids it is also possible to use the corresponding polycarboxylic anhydrides or appropriate polycarboxylic esters of lower alcohols or mixtures thereof to prepare the polyesters. The polycarboxylic acids are preferably aliphatic and/or cycloaliphatic in nature and may optionally be substituted, for example by halogen atoms, and/or unsaturated. Examples thereof include:

succinic acid, adipic acid, suberic acid, azelaic acid, sebacic acid, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, dimeric and trimeric fatty acids.

Optional monobasic carboxylic acids are preferably saturated or unsaturated fatty acids, for example 2-ethylhexanoic acid, palmitic acid, stearic acid, oleic acid, ricinoleic acid, linoleic acid, ricinenic acid, linolenic acid and also technical grade fatty acid mixtures as obtainable inter alia from natural raw materials (eg coconut fat, linseed oil, soybean oil, castor oil).

Useful polyhydric alcohols include for example ethylene glycol, 1,2-propanediol, 1,3-propanediol, 1,4-butanediol, 2,4-butanediol, 2,3-butanediol, 1,6-hexanediol, 1,-8-octanediol, neopentylglycol, cyclohexanedimethanol (1,4-bishydroxymethylcyclohexane), 2-methyl-1,3-propanediol, glycerol, trimethylolpropane, 1,2,6-hexanetriol, 1,2,4-butanetriol, trimethylolethane, pentaerythritol, quinitol, mannitol and sorbitol, methylglycoside, also diethylene glycol, dipropylene glycol, polypropylene glycols, dibutylene glycol and polybutylene glycols. The polyesters may include fractions with terminal carboxyl groups. It is also possible to use polyesters formed from lactones, for example ε-caprolactone, or hydroxycarboxylic acids, for example ω-hydroxycaproic acid.

Similarly, the polyethers which are useful according to the invention and which preferably have two hydroxyl groups are those of the kind known per se and are prepared for example by polymerization of tetrahydrofuran or epoxides such as ethylene oxide, propylene oxide, butylene oxide, styrene oxide or epichlorohydrin with itself, for example in the presence of BF₃, or by addition of these epoxides, optionally in mixture or in succession, to starter components having reactive hydrogens such as alcohols and amines, for example water, ethylene glycol or 1,2-propylene glycol.

Preferably, the polyethers used as formative components contain at maximum only sufficient ethylene oxide units for the resulting polyurethane(ureas) to contain less than 2% by weight of oxyethylene segments —CH₂—CH₂—O—. Preference is given to using polyesters which are free of ethylene oxide for preparing the polyurethane(ureas).

It is similarly possible to use polyethers which have been modified by means of vinyl polymers and as formed for example by polymerization of styrene, acrylonitrile in the presence of polyethers (U.S. Pat. Nos. 3,383,351, 3,304,273, 3,523,093, 3,110,695, DE-C 11 52 536), while the more highly functional polyethers which may optionally be used in a fraction are formed in a similar manner by conventional alkoxylation of more highly functional starter molecules, for example ammonia, ethanolamine, ethylenediamine, trimethylolpropane, glycerol or sucrose.

Useful polythioethers include in particular the condensation products of thiodiglycol with itself and/or with other glycols, dicarboxylic acids, formaldehyde, amino carboxylic acids or amino alcohols.

Useful hydroxyl-containing polycarbonates include those of the kind which is known per se and which are preparable for example by reaction of diols such as 1,3-propanediol, 1,4-butanediol and/or 1,6-hexanediol with diaryl carbonates, for example diphenyl carbonate or phosgene.

Useful polyesteramides and polyamides include for example the predominantly linear condensates obtained from polybasic saturated and unsaturated carboxylic acids or anhydrides thereof and polyfunctional saturated or unsaturated amino alcohols, diamines, polyamines and their mixtures.

It is similarly possible to use polyhydroxy compounds which already contain a urethane or urea group.

Representatives of the cited polyisocyanate and hydroxy compounds to be used in the process according to the invention are described for example in High Polymers, Vol. XVI, “Polyurethanes, Chemistry and Technology”, authored by Saunders-Frisch, Interscience Publishers, New York, London, volume I, 1962, pages 32-42 and pages 44 to 54 and volume II, 1964, pages 5-6 and 198-199, and also in Kunststoff-Handbuch, volume VII, Vieweg-Höchtlen, Carl-Hanser-Verlag, Munich, 1966, for example on pages 45 to 71.

Preference is likewise given to copolymers of styrene, namely plastics of the type acrylonitrile-butadiene-styrene (ABS) or of the type acrylonitrile-styrene-acrylate (ASA). For the purposes of the present invention, ABS plastics shall refer to plastics as specified in the draft European standard ISO 2580-1. Preferably they are styrene-acrylonitrile copolymers having a continuous phase based on copolymers of styrene/alkyl-substituted styrene and acrylonitrile and a disperse elastomeric phase, predominantly based on butadiene, although admixtures of other components can be present. These other components can be monomers or polymers of compounds other than acrylonitrile, butadiene and substituted or unsubstituted styrene, although these components are not present in more than 30% by weight. When the other component is a polymer, it is preferably dispersed in a matrix of a styrene-acrylonitrile copolymer. Monomers which can be present include acrylate ester, butadiene, maleic anhydride and other anhydrides, and N-phenylmaleimide and maleic esters.

ASA plastics for the purposes of the present invention are the plastics which are specified in the draft European standard ISO 6402-1. ASA here is a plastic having a continuous phase substantially based on a styrene-acrylonitrile copolymer and a disperse elastomeric phase mainly based on acrylic ester. Other new components may be present. If these are monomers other than acrylonitrile, substituted or unsubstituted styrene or acrylate ester, the proportion of these is preferably not more than 30% by weight. If they are polymers, then these polymers are not based on acrylonitrile, substituted or unsubstituted styrene or acrylate ester and are present at not more than 1% by weight. Furthermore, these polymers can be dispersed in a matrix of a styrene-acrylonitrile copolymer. The abovementioned monomers are acrylate ester, butadiene, maleic anhydride and other anhydrides or N-phenylmaleimide and maleic ester.

Microcapsules are preferably capsules having an average particle size of 0.1 to 100 μm, more preferably 1 to 30 μm and especially 2 to 20 μm and contain an active component.

Examples of preferred capsule materials are polyureas formed from polyisocyanates and polyamines, polyamides formed from polymeric acyl chlorides and polyamines, polyurethanes formed from polyisocyanate and polyalcohols, polyesters formed from polyisocyanates and polyamines, polyamides formed from polyisocyanates and polyamines, polyesters formed from polymeric acyl chlorides and polyalcohols, epoxy resins formed from epoxy compounds and polyamines, melamine-formaldehyde compounds formed from melamine-formaldehyde prepolymers, urea resins formed from urea-formaldehyde prepolymers, ethylcellulose, polystyrene, polyvinyl acetate and gelatin.

Varying the wall thickness is the simplest way of influencing the retention properties of the capsules, ie the properties which govern the release of the active component. This can be used for example to create “slow release” capsules which, applied to the web, will give off the core material (active component) continuously over a long period, but also on-demand capsules for webs where the core material is to be released on application of mechanical pressure only.

Preferred wall thicknesses for the microcapsules are in the range of 2-25%, preferably 3-15% and especially 4-10% wall fraction, each percentage being based on the sum total of the capsule core materials.

Preference is given to microcapsules whose walls comprise reaction products of guanidine compounds and polyisocyanates.

The wall fraction of the microcapsules is directly proportional to the fraction of the primary wall former, the polyisocyanate.

Useful guanidine compounds for forming the microcapsules include for example those of the formula (I)

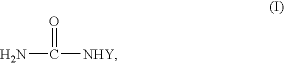

where

X is HN═,

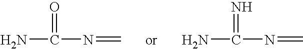

and

Y is H—, NC—, H₂N—, HO—,

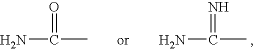

or their salts with acids.

The salts can be for example the salts of carbonic acid, nitric acid, sulphuric acid, hydrochloric acid, silicic acid, phosphoric acid, formic acid and/or acetic acid. The use of salts of guanidine compounds of the formula (I) can take place in combination with inorganic bases in order that the salts may be converted in situ into the free guanidine compounds of the formula (I). Useful inorganic bases for this purpose include for example alkali and/or alkaline earth metal hydroxides and/or alkaline earth metal oxides. Preference is given to aqueous solutions or slurries of these bases, especially aqueous sodium hydroxide solution, aqueous potassium hydroxide solution or aqueous solutions or slurries of calcium hydroxide. It is also possible to use combinations of a plurality of bases.

It is frequently advantageous to use the guanidine compounds of the formula (I) as salts since they are commercially available in this form and free guanidine compounds are in some instances substantially insoluble in water or not stable in storage. When inorganic bases are used, they may be used in stoichiometric, substoichiometric or superstoichiometric amounts, based on salts of guanidine compounds. Preference is given to using 10 to 100 equivalent % of inorganic base (based on salts of the guanidine compounds). The addition of inorganic bases has the consequence that, for microencapsulation, guanidine compounds having free NH₂ groups are available in the aqueous phase for reaction with the polyisocyanates in the oil phase. For microencapsulation, salts of guanidine compounds and bases are advantageously added separately to the aqueous phase.

Preference is given to using guanidine or salts of guanidine with carbonic acid, nitric acid, sulphuric acid, hydrochloric acid, silicic acid, phosphoric acid, formic acid and/or acetic acid.

It is particularly advantageous to use salts of guanidine compounds with weak acids. These are in equilibrium with the corresponding free guanidine compound in aqueous solution as a consequence of hydrolysis. The free guanidine compound is consumed during the encapsulation process and is constantly regenerated according to the law of mass action. Guanidine carbonate exhibits this advantage to a particular degree. When salts of guanidine compounds with weak acids are used, there is no need to add inorganic bases to release the free guanidine compounds.

Useful guanidine compounds of the formula (I) for the present invention may also be prepared by ion exchange from their water-soluble salts according to the prior art using commercially available basic ion exchangers. The eluate from the ion exchanger can be utilized directly for capsule wall formation by mixing it with the oil-in-water emulsion.

For example, sufficient guanidine compounds can be used so that 0.2 to 4.0 mol of free NH₂ groups are introduced into or released in the water phase in the form of guanidine compounds per mole of NCO groups present as polyisocyanate in the oil phase. This amount is preferably 0.5 to 1.5 mol. When guanidine compounds are used in a substoichiometric amount, free NCO groups remain after the reaction with the polyisocyanate. These then generally react with water, which is usually not critical since this reaction gives rise to new, free amino groups capable of crosslinking.

The guanidine compounds are preferably used in the form of aqueous solutions. The concentration of such solutions is not critical and is generally limited only by the solubility of the guanidine compounds in water. Useful aqueous solutions of guanidine compounds are 1 to 20% by weight in strength for example.

Useful polyisocyanates for producing microcapsules include a very wide range of aliphatic, aromatic and aromatic-aliphatic difunctional and higher isocyanates, especially those known for producing microcapsules. Preference is given to using aliphatic polyisocyanates. Particular preference is given to using hexamethylene diisocyanate, isophorone-diisocyanate and/or derivatives of hexamethylene diisocyanate and of isophorone diisocyanate that have free isocyanate groups and contain biuret, isocyanurate, uretidione and/or oxadiazinetrione groups. Mixtures of various polyisocyanates can also be used. Some useful polyisocyanates are described for example in EP-A 227 562, EP-A 164 666 and EP-A 16 378.

A preferred embodiment of the webs according to the invention utilizes microcapsules whose walls comprise reaction products of guanidine compounds, polyamines and polyisocyanates.

Preferably, the guanidine compound is used in an amount of 0.5-0.99 and especially 0.51 to 0.75 mol equivalents, based on polyisocyanate, and the polyamine compound in an amount of 0.1-1 and especially 0.5 to 0.75 mol equivalents, based on polyisocyanate, the total amount of guanidine compound and polyamine being greater than 1.1 mol equivalents, based on polyisocyanate.

Possible ingredient materials for the microcapsules include various compounds, for example dye precursors, adhesives, pharmaceuticals, insecticides, fungicides, herbicides, repellants and also scents.

Scents are particularly preferred.

Useful scents include all commercially available hydrophobic and hence water-insoluble scents as described for example by P. Frakft et al. in Angew. Chem., 2000, 112, 3106-3138. In the case of substances which are soluble in water as well as oils, the addition of odour-neutral, sparingly volatile oils such as paraffins, alkylaromatics or esters can make use possible.

The substrates preferably contain 1 to 100 g/m² and especially 20 to 80 g/m² of polymer including microcapsules.

The polymer coat preferably contains 0.5 to 10% by weight and especially 1 to 8% by weight of microcapsules.

The substrate according to the invention preferably contains the microcapsules in 50% and especially in 80% of the cross section of the polymer coat.

The polymer coat on the substrates according to the invention may additionally contain further ingredients. Filler or colorant may be mentioned in this context.

The polymer coat can be porous and hence water vapour pervious, but it can also be irregular or smooth. After coagulation, other coats can be applied to modify the properties of the polymer coat. For this, these coats can be applied for example by spraying, coating, impregnating or transferring.

The substrates according to the invention are especially useful as automotive interior parts, for example seat cover materials, covers for furniture such as armchairs, chairs and sofas, clothing or shoe materials.

The invention further provides a process for producing substrates according to the invention, which is characterized in that dissolved polymer and microcapsules are applied to the substrate and the polymer coagulates on the substrate in a coagulation bath.

In a preferred embodiment of the process according to the invention, the polymer is used as a solution in an organic solvent, preferably aprotic solvents, such as for example DMF, DMSO or dimethyl acetate.

The preferred solvent is DMF. The polymer solution preferably contains 30 to 80% by weight of polymer, 20 to 70% by weight of solvent and optionally further additives. As such there may be mentioned for example fillers, colorants, softeners, deaerators, etc.

It will be appreciated that the polymer solution can also contain the microcapsules in a dispersed state. These microcapsules are preferably used in the form of an aqueous dispersion having a microcapsule content of about 5 to 60% by weight and especially 25 to 52% by weight.

The polymer solution may contain for example 1 to 10% and especially 2 to 5% by weight of this microcapsule dispersion.

The polymer solution is preferably mixed together shortly before application to the substrate.

The polymer solution and the microcapsules, especially in the form of their dispersion, can be applied to the substrate in succession or conjointly, in which case possible application techniques include for example knifecoating, spraying, rollcoating or spreadcoating.

Knifecoating is preferred.

The invention further provides a preparation containing

a) organic solvent, especially 20 to 67% by weight, preferably DMF,

b) at least one polymer dissolved in the organic solvent a), preferably in an amount of 30 to 60% by weight, the polymer preferably being selected from those mentioned above,

c) at least one dispersant, preferably 1 to 10% by weight, the dispersant preferably being selected from those indicated above, and

d) microcapsules containing an active component, preferably 1 to 10% by weight, the microcapsules and active components preferably each being selected from those indicated above,

and the percentages are each based on the preparation.

The coagulation is preferably effected by introducing the substrate coated with a polymer solution and microcapsules into an aqueous coagulation bath.

This coagulation bath preferably contains water and optionally further additives. The coagulation bath preferably has a temperature of 10 to 50° C. and especially 20 to 40° C. In a preferred embodiment, the solvent used is recovered from the coagulation bath by distillation. After coagulation has taken place, the coated substrate is preferably dried and optionally aftertreated. The drying preferably takes place at 20 to 200° C. Useful aftertreating steps include for example the application of further coats.

The polymer coat thickness of the coated substrates is preferably in the range from 0.1 to 2 mm.

The process according to the invention can be carried out batchwise or continuously. A continuous operation is preferred.

The invention further provides for the use of the substrates according to the invention as a leather substitute, especially as clothes, furniture or cover materials for automotive seats.

### EXAMPLES

### Example 1

Two aromatic polyester-polyetherurethanes (each 325 parts) having different softening ranges ((i) 170 to 180° C. and (ii) 190 to 200° C. are dissolved in 312.85 parts of DMF. To this solution are added 2.6 parts of a dispersant which is based on polyether/polydimethylsiloxane, 0.65 part of a silicone oil, 20 parts of a 50% pigment dispersion in PEG 400 and 10 parts of a 50% aqueous microcapsule dispersion having microcapsule walls of a polyurea, formed by reaction of trimeric HDI (hexamethylene diisocyanate) and guanidine carbonate. The active component the microcapsules contain is the scent Blue Line D 13049F from Haarmann & Reimer.

This dispersion is spreadcoated onto woven cotton fabric and thereafter coagulated in a waterbath at room temperature. This is followed by drying at a temperature of 80 to 140° C.

Evaluation of odour:

| | |
|---|---|
| directly after coagulation: | very intensive |
| 8 hours after coagulation: | very intensive |
| 2 days after coagulation: | very intensive |
| 15 days after coagulation: | intensive |

### Example 2

Example 1 was repeated using just 5 parts of the microcapsule dispersion, but 317.85 parts of DMF.

Evaluation of odour:

| | |
|---|---|
| directly after coagulation: | very intensive |
| 8 hours after coagulation: | very intensive |
| 2 days after coagulation: | intensive |
| 15 days after coagulation: | intensive |

### Example 3

Example 1 was repeated, except that the amount of DMF is increased to 390.55 parts and the amount of the two polymers is reduced to 286 parts for each.

Evaluation of odour:

| | |
|---|---|
| directly after coagulation: | very intensive |
| 8 hours after coagulation: | very intensive |
| 2 days after coagulation: | very intensive |
| 15 days after coagulation: | intensive |

1. Polymer-coated substrates containing microcapsules in the polymer coat.

2. Substrates according to claim 1, characterized in that the substrates used are leather, textile, leatherlike material, web, paper or plastics films or sheets.

3. Substrates according to claim 1, characterized in that the polymer is a polyurethane, polyurethaneurea, polyacrylonitrile or styrene copolymer.

4. Substrate according to claim 1, characterized in that the microcapsules contain scents.

5. Process for producing substrates according to claim 1, characterized in that dissolved polymer and microcapsules are applied to the substrate and the polymer coagulates on the substrate in a coagulation bath.

6. Use of the substrates according to claim 1 as leather substitutes such as cover materials for furniture and car seats.

7. Preparation containing
a) organic solvent
b) at least one polymer dissolved in the organic solvent a)
c) at least one dispersant
d) microcapsules containing an active component.
